(19) United States
(12) Patent Application Publication
(10) Pub. No.: US 2026/0356416 A1
(43) Pub. Date: Nov. 12, 2026

(54) FOLDABLE BABY STROLLER

(71) Applicant: Mima International Holdings Limited, Tortola (VG)

(72) Inventors: David Chuanhankho KHO, Bangkok (TH); Situ JIACHANG, Hesan (CN)

(21) Appl. No.: 19/205,436

(22) Filed: May 12, 2025

(51) Int. Cl. B62B 7/08; A47D 13/04; B62B 9/20

(52) U.S. Cl. CPC B62B 7/08; A47D 13/04; B62B 9/20; B62B 2205/20

(57) ABSTRACT

A foldable baby stroller includes a stroller frame and a folding mechanism. The stroller frame comprises a rear wheel bracket, a front wheel bracket, a support frame, and a push rod, all pivotally connected around a joint. The support frame has a notch, and a folding mechanism is switchable between unfolded and folded states. The folding mechanism includes a pulley, a control member, a pull cord, a locking member, and a linkage member. When the push rod rotates to the folded-back position, the control member drives the locking member to disengage from the notch, allowing the support frame and front wheel bracket to rotate synchronously relative to the rear wheel bracket, thereby enabling compact folding of the stroller.

### BACKGROUND OF THE INVENTION

The present invention relates to a baby stroller and more particularly to a foldable baby stroller.

Conventional baby strollers typically include a stroller frame, a backrest, and a seat mounted on the frame. When folding the stroller, users usually need to operate the frame, backrest, and seat separately. Such a folding process is inconvenient and requires multiple steps, resulting in cumbersome operation and difficulty in quickly folding the stroller.

### SUMMARY OF THE INVENTION

The primary objective of the present invention is to provide a foldable baby stroller, which includes a stroller frame and a folding mechanism. The stroller frame includes a rear wheel bracket, a front wheel bracket, a support frame, and a push rod. One end of the rear wheel bracket is provided with a joint internally provided with a first locking groove. The front wheel bracket is pivotally connected to the joint about a front shaft. The support frame is pivotally connected to the joint about a rear shaft. The support frame is provided with a notch along a radial outer periphery of the rear shaft. The push rod is pivotally connected to the support frame and is rotatable between an unfolded position and a folded-back position.

The folding mechanism is switchably connected to the stroller frame between an unfolded state and a folded state. The folding mechanism includes a first pulley, a control member, a first pull cord, a locking member, and a linkage member. The first pulley is pivotally connected to the support frame and rotatable with the push rod. The control member is pivotally connected to the support frame. One end of the first pull cord is connected to the first pulley and the other end is connected to the control member. The locking member is radially movable along the rear shaft and disposed in the first locking groove. The linkage member is pivotally connected to the front wheel bracket about a first shaft and pivotally connected to the support frame about a second shaft. The front shaft, rear shaft, first shaft, and second shaft are all arranged in parallel.

When the folding mechanism is in the unfolded state, the locking member is embedded in the notch, such that the support frame is prevented from rotating relative to the rear wheel bracket. The push rod is rotated to the folded-back position to switch the folding mechanism to the folded state.

When the folding mechanism is in the folded state, the control member pushes the locking member out of the notch, such that the support frame and the front wheel bracket rotate synchronously relative to the rear wheel bracket.

In an embodiment, the front wheel bracket is provided with a second locking groove along a direction parallel to the front shaft. The second locking groove includes a movable portion and a locking portion. The movable portion is arcuate about the front shaft. The locking portion is connected to the movable portion and extends radially along the front shaft. When the folding mechanism is in the unfolded state, the locking member is disposed in the locking portion to prevent the front wheel bracket from rotating relative to the rear wheel bracket. When the folding mechanism is in the folded state, the locking member moves into the movable portion, and the locking member moves within the movable portion as the front wheel bracket rotates.

In an embodiment, the rear wheel bracket is provided with two stabilizing blocks and two elastic members. The two stabilizing blocks are disposed on two opposite axial sides of the rear wheel bracket and are radially movable along the rear shaft. The two stabilizing blocks are respectively connected to two opposite ends of the locking member. The two elastic members are connected to the two stabilizing blocks. One end of each elastic member abuts against the rear wheel bracket and the other end abuts against the corresponding stabilizing block, such that the two elastic members can push the two stabilizing blocks to drive the locking member toward the rear shaft.

In an embodiment, the rear wheel bracket is provided with a limiting rod along a direction parallel to the front shaft. The front wheel bracket is provided with a limiting slot along the direction parallel to the front shaft. The limiting slot is arcuate about the front shaft. The limiting rod is movably inserted into the limiting slot.

In an embodiment, the support frame is provided with a plug member, a plug spring, and a cross rod. The plug member is radially movable within the support frame along the rear shaft. The plug spring is disposed in the support frame. One end of the plug spring abuts against the support frame and the other end abuts against the plug member to push the plug member away from the rear shaft. The plug member has a closed end opposite to the plug spring. The closed end is disposed in the notch. One end of the cross rod is slidably connected to the control member and the other end is connected to the plug member. When the folding mechanism is in the unfolded state, the closed end abuts against the locking member. When the folding mechanism is in the folded state, the closed end moves away from the rear shaft and blocks the notch.

In an embodiment, the folding mechanism further includes a return elastic member sleeved on the first pull cord. One end of the return elastic member abuts against the support frame and the other end abuts against the control member.

In an embodiment, the support frame is provided with a first engaging portion. The push rod is provided with a shaft rod, a second engaging portion, and a push button. The shaft rod passes through the first engaging portion and is pivotally connected to the support frame. The first engaging portion and the second engaging portion are adjacent to and surround the shaft rod. The folding mechanism further includes a second pulley and an engaging member. The second pulley is rotatably sleeved on the shaft rod and disposed within the second engaging portion. The second pulley is connected to a second pull cord. One end of the second pull cord opposite to the second pulley is connected to the push button. The engaging member is axially slidably sleeved on the shaft rod. When the push button is released, the engaging member engages both the first engaging portion and the second engaging portion to hold the push rod in the unfolded position. When the push button is pressed, the second pulley is driven by the second pull cord to push the engaging member toward the support frame and disengage the engaging member from the second engaging portion, allowing the push rod to rotate relative to the support frame.

The present invention will become clearer in light of the following detailed description of illustrative embodiments of this invention described in connection with the drawings.

### BRIEF DESCRIPTION OF DRAWINGS

FIG. 1 is a perspective view of a foldable baby stroller according to the present invention.

FIG. 2 is an exploded perspective view of a push button of the foldable baby stroller.

FIG. 3 is an exploded perspective view of a push rod of the foldable baby stroller.

FIG. 4 is another exploded perspective view of the push rod of the foldable baby stroller from a different angle.

FIG. 5 is an exploded perspective view of a joint of the foldable baby stroller.

FIG. 6 is another exploded perspective view of the joint from a different angle.

FIG. 7 is a cross sectional view of the push button.

FIG. 8 is a cross sectional view of the push rod in an unfolded position.

FIG. 9 is a cross sectional view taken along line 9-9 of FIG. 8, showing a second pull cord.

FIG. 10 is a cross sectional view taken along line 10-10 of FIG. 8, showing a first pull cord.

FIG. 11 is a cross sectional view of the joint, showing a folding mechanism in an unfolded state.

FIG. 12 is another cross sectional view of the joint, showing the folding mechanism in the unfolded state from a different angle.

FIG. 13 is another cross sectional view of the joint, showing the folding mechanism in the unfolded state from a different perspective than FIG. 12.

FIG. 14 is an action diagram illustrating the pressing operation of the push button.

FIG. 15 is a cross sectional view of the push rod in a folded-back position.

FIG. 16 is an action diagram of the push rod in the folded-back position.

FIG. 17 is a cross sectional view taken along line 17-17 of FIG. 15, showing the first pull cord.

FIG. 18 is an action diagram of the folding mechanism in the folded state.

FIG. 19 is a cross sectional view of the joint, showing the folding mechanism in the folded state from another angle.

FIG. 20 is another cross sectional view of the joint, showing the folding mechanism in the unfolded state from a different perspective than FIG. 19.

FIG. 21 is a perspective view of the stroller after folding.

### DETAILED DESCRIPTION OF THE INVENTION

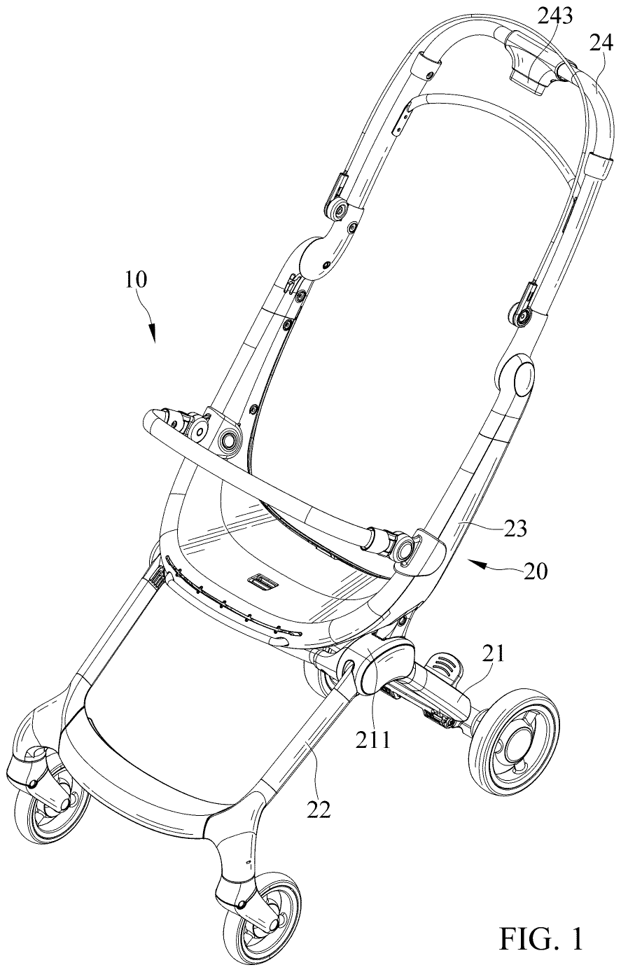

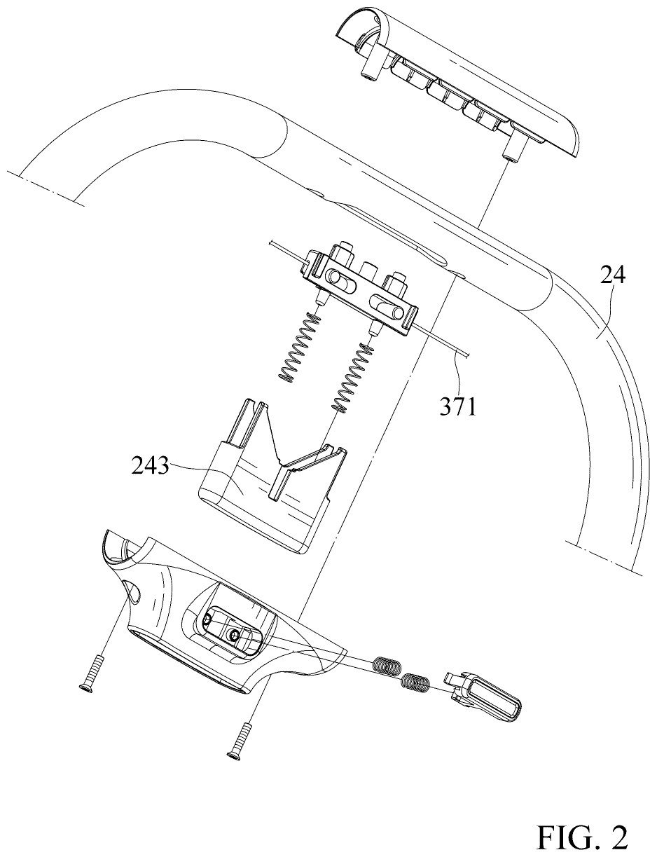

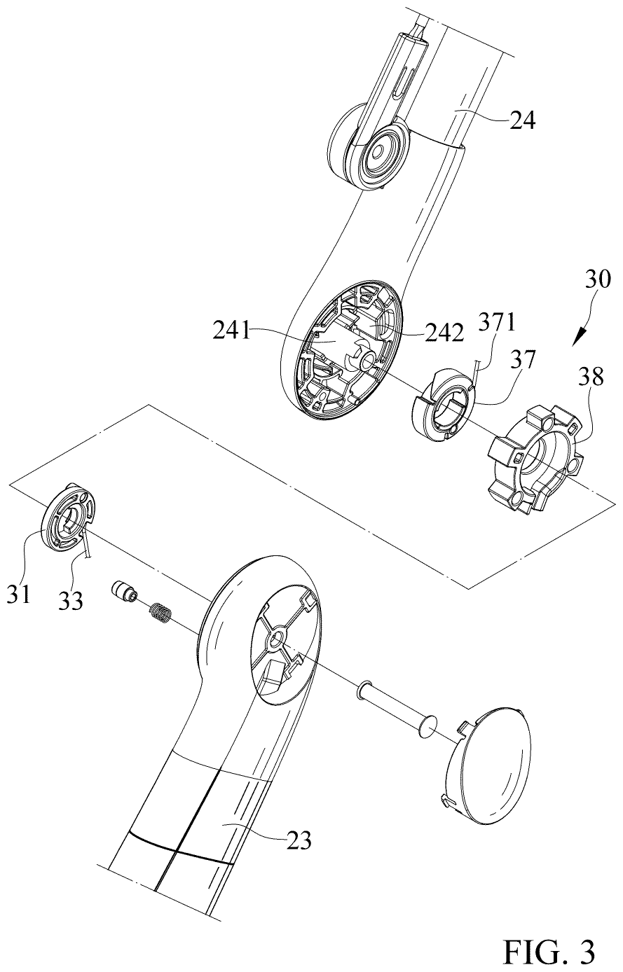

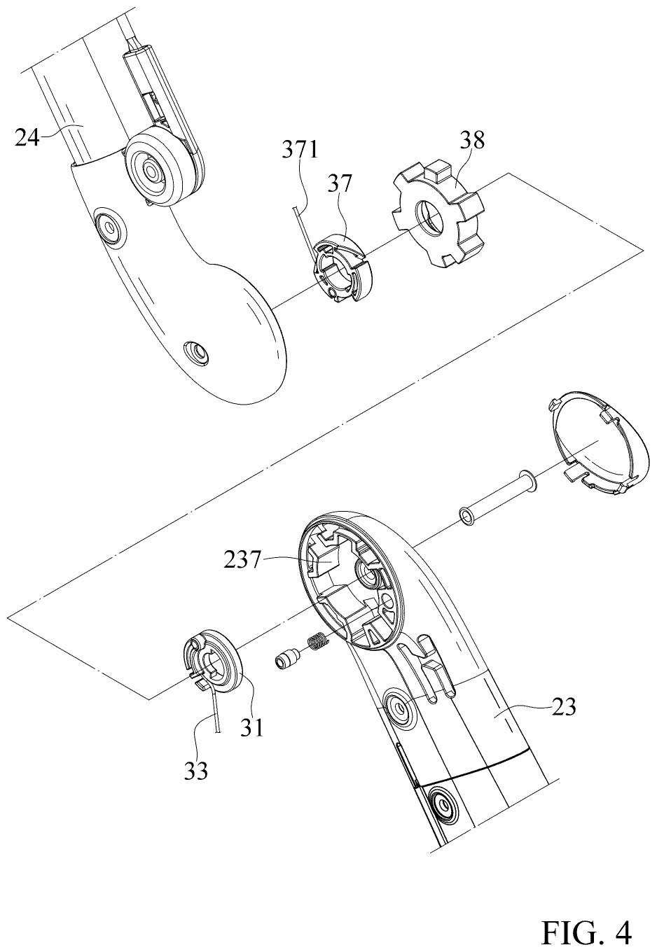

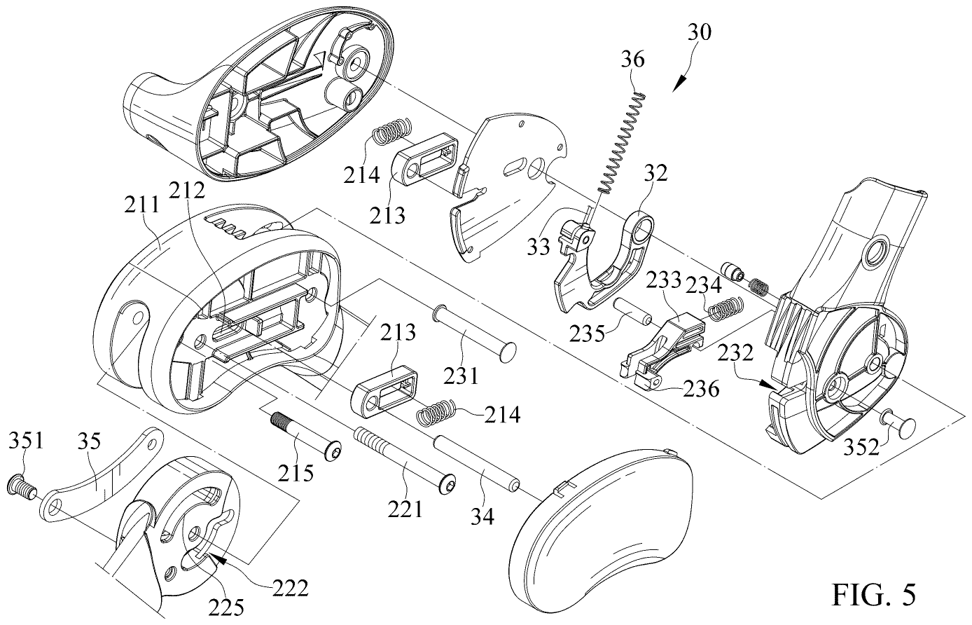

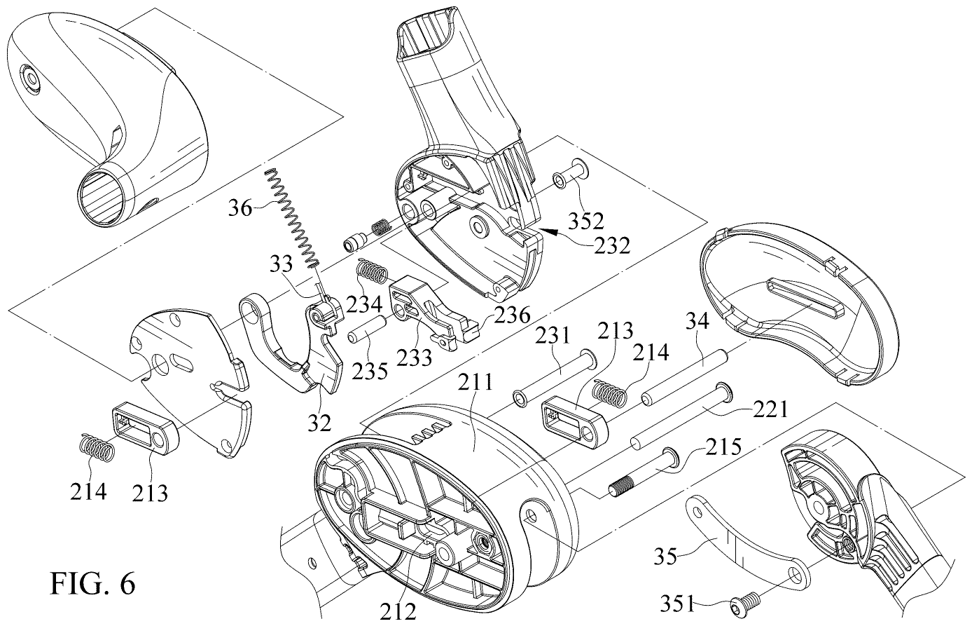

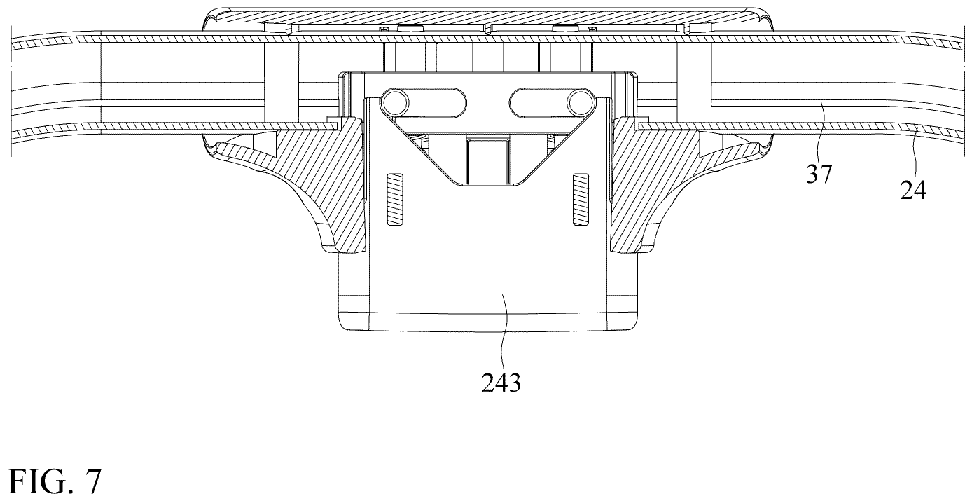

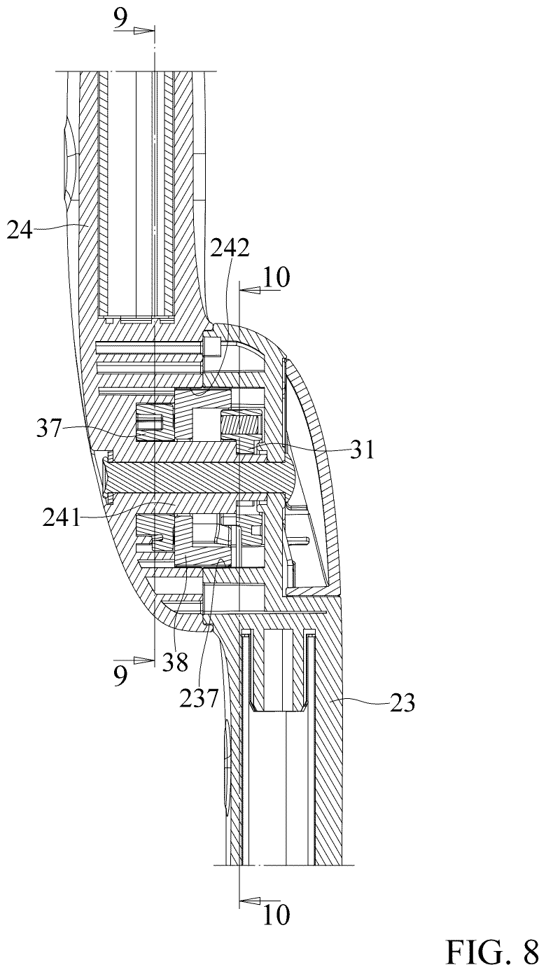

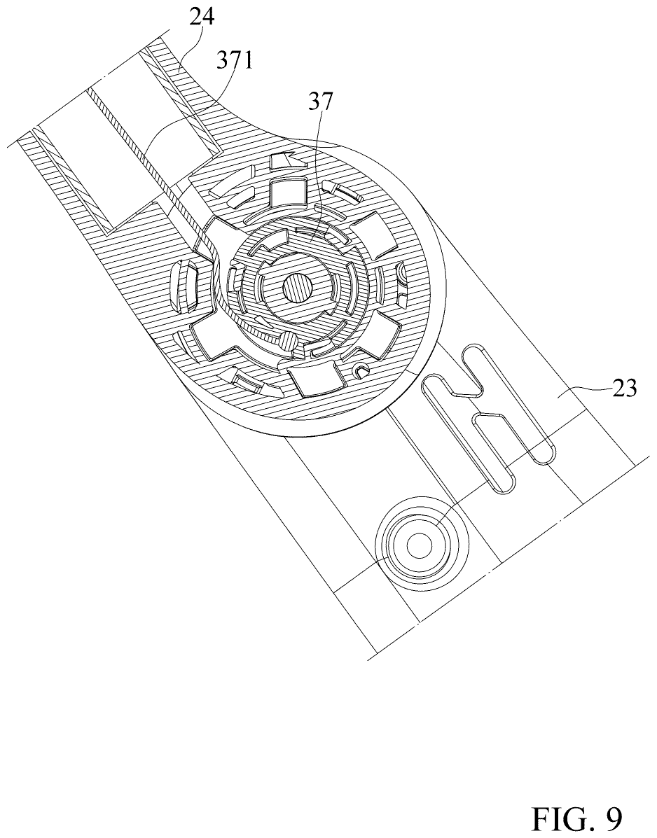

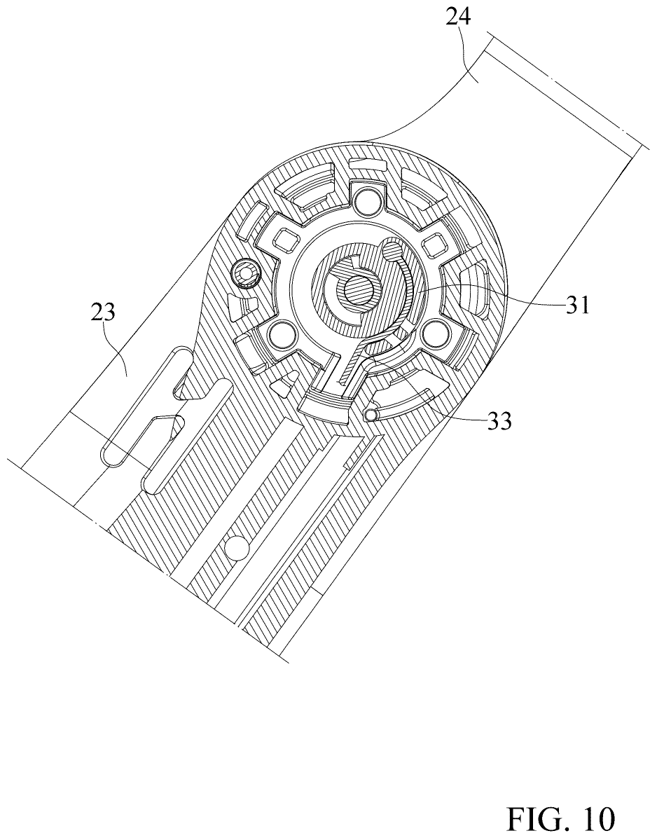

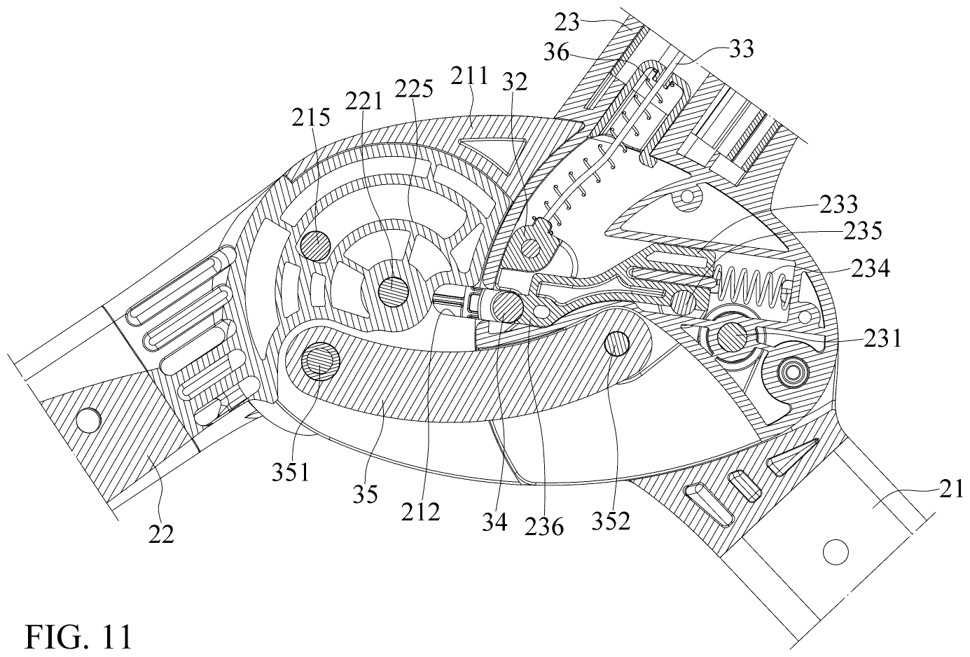

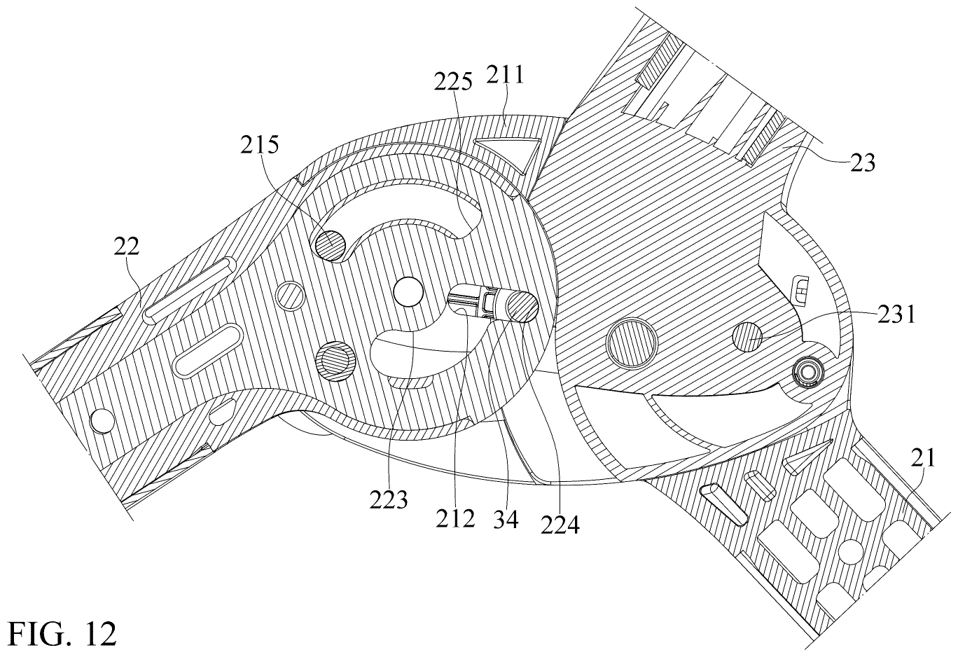

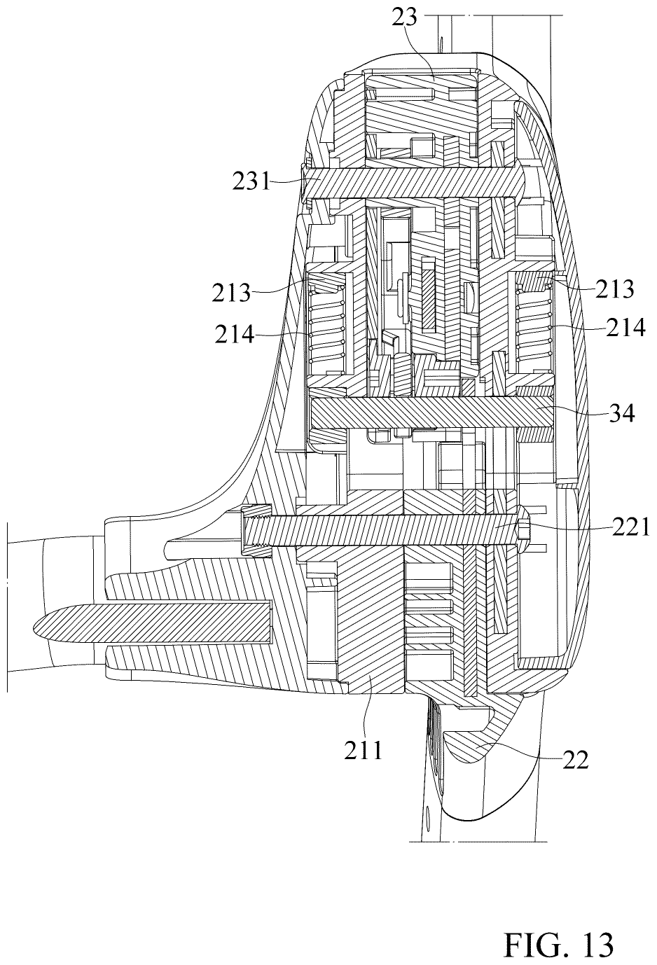

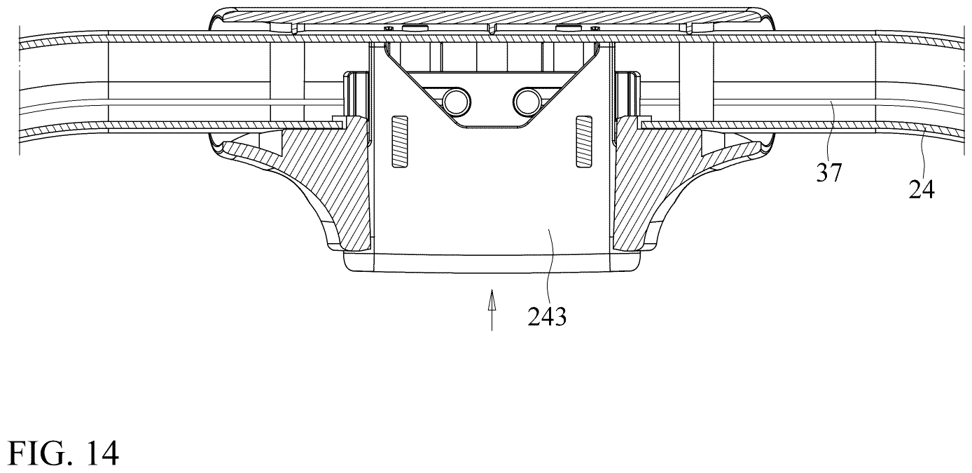

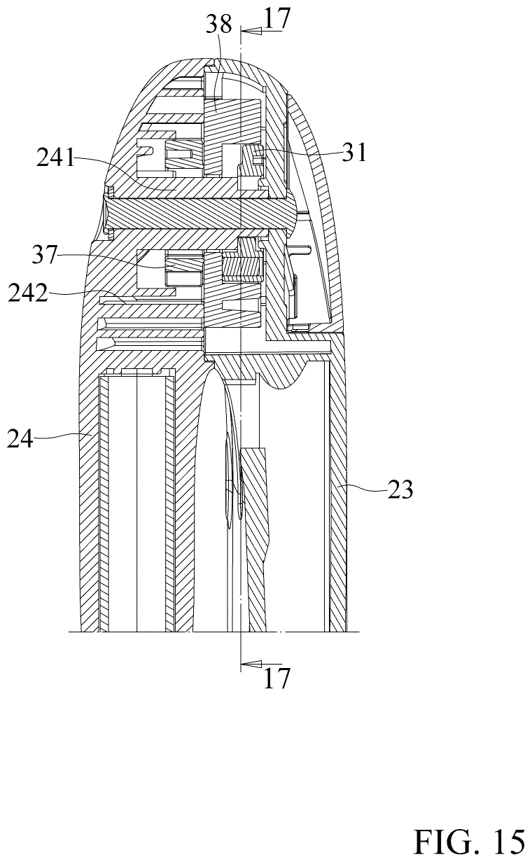

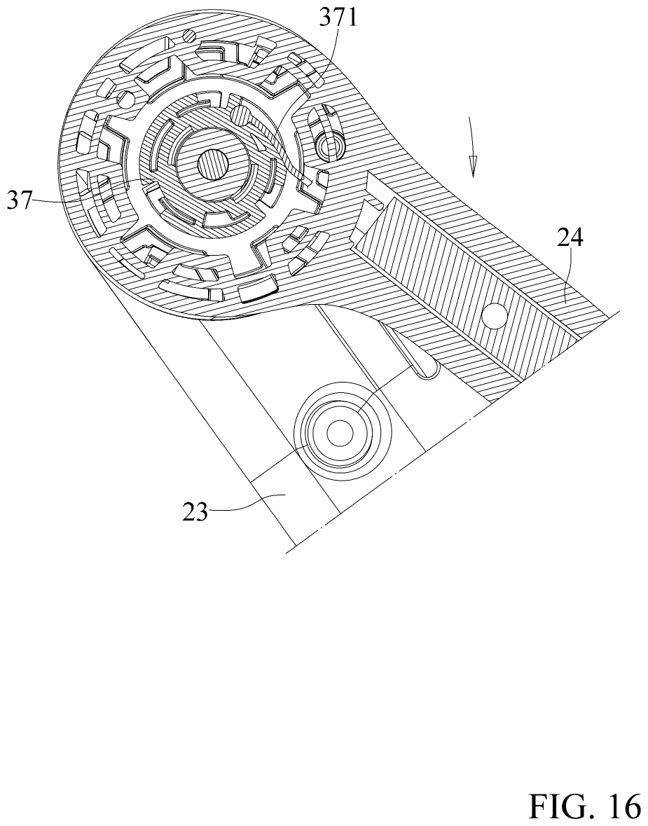

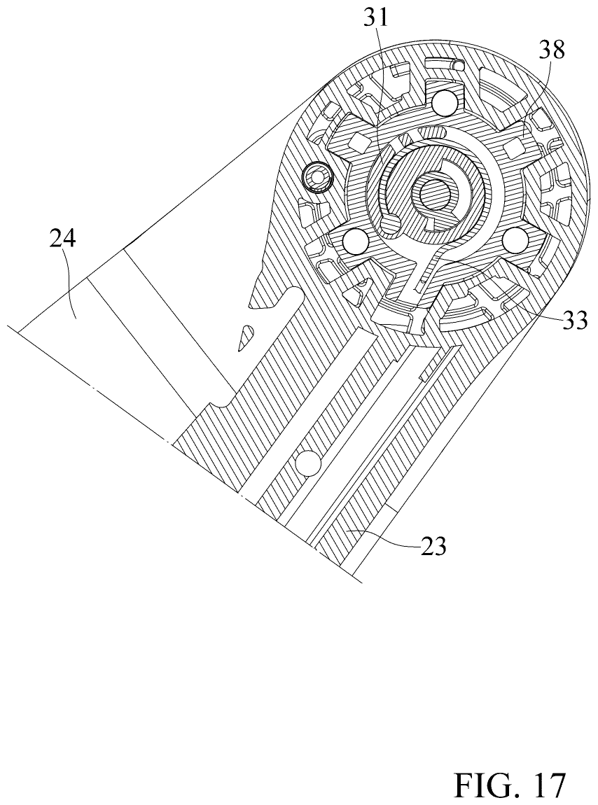

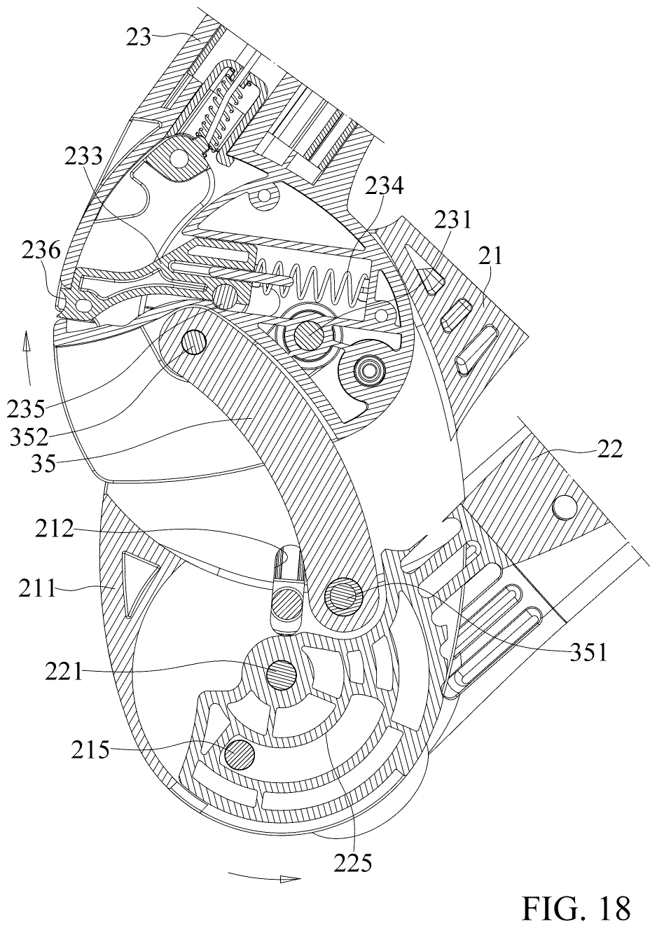

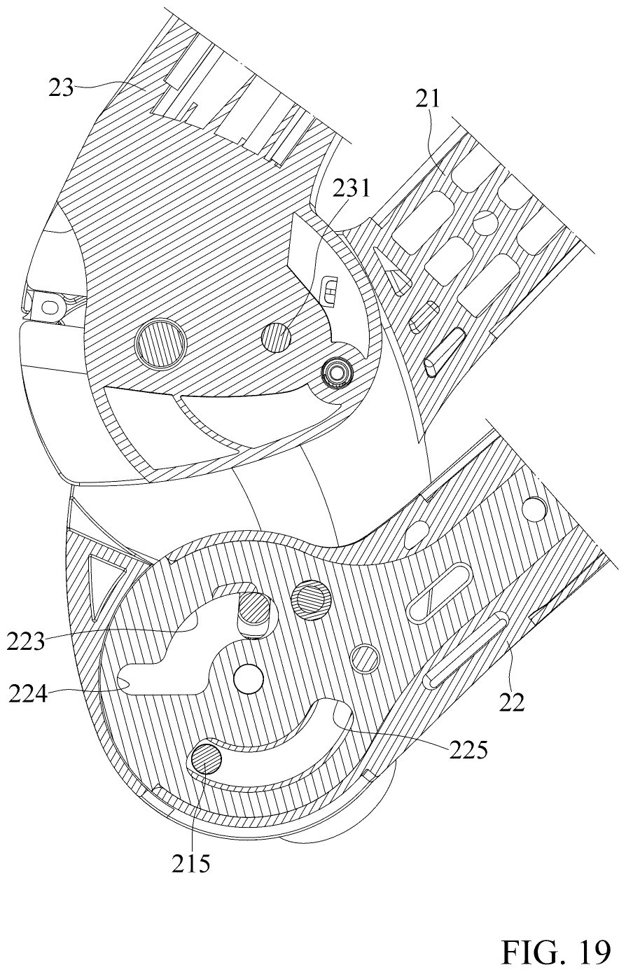

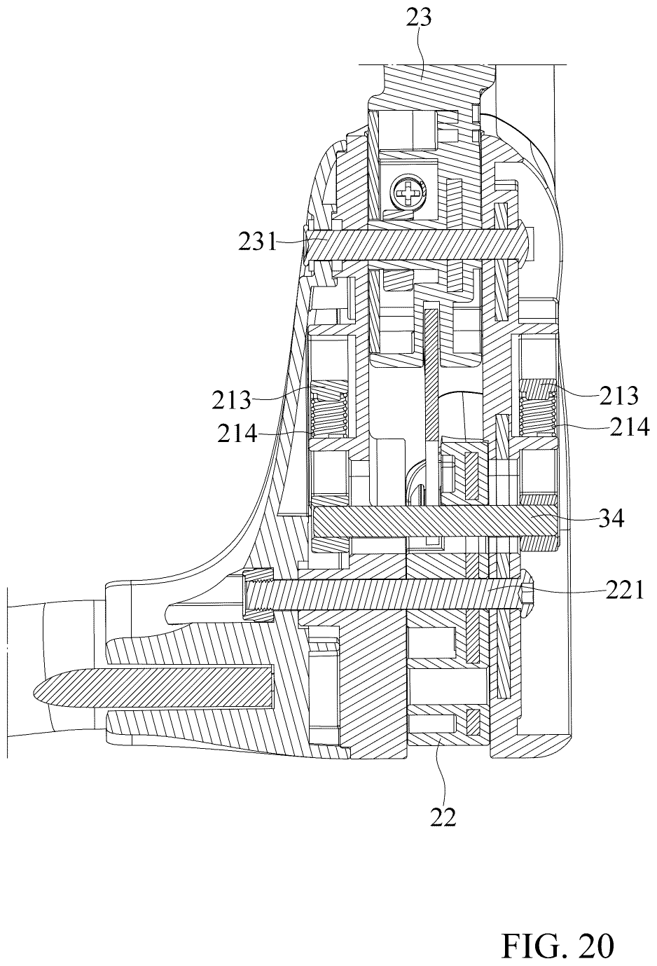

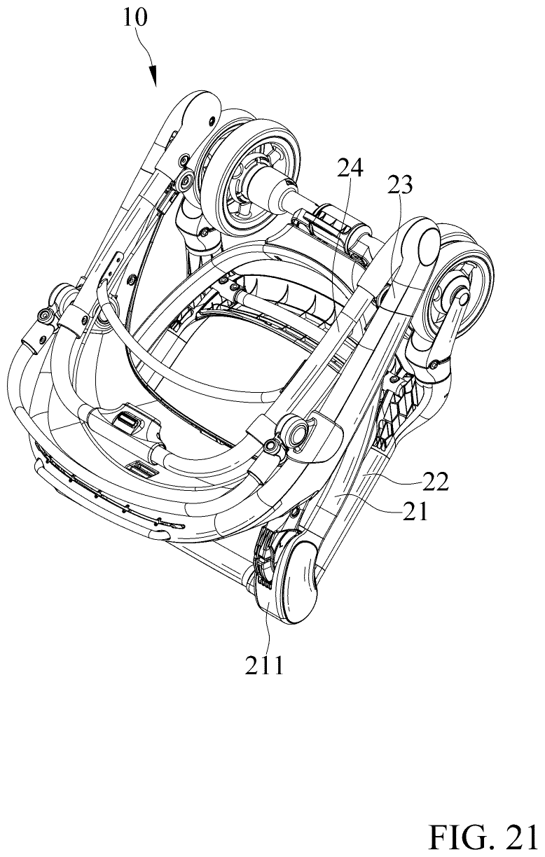

Referring to FIGS. 1 to 21, the present invention discloses a foldable baby stroller 10, which includes a stroller frame 20 and a folding mechanism 30.

The stroller frame 20 includes a rear wheel bracket 21, a front wheel bracket 22, a support frame 23, and a push rod 24, wherein one end of the rear wheel bracket 21 is provided with a joint 211 internally provided with a first locking groove 212, wherein the front wheel bracket 22 is pivotally connected to the joint 211 about a front shaft 221, wherein the support frame 23 is pivotally connected to the joint 211 about a rear shaft 231, wherein the support frame 23 is provided with a notch 232 along a radial outer periphery of the rear shaft 231, and wherein the push rod 24 is pivotally connected to the support frame 23 and is rotatable between an unfolded position and a folded-back position.

The folding mechanism 30 is switchably connected to the stroller frame 20 between an unfolded state and a folded state. The folding mechanism 30 includes a first pulley 31, a control member 32, a first pull cord 33, a locking member 34, and a linkage member 35. The first pulley 31 is pivotally connected to the support frame 23 and rotatable with the push rod 24. The control member 32 is pivotally connected to the support frame 23. One end of the first pull cord 33 is connected to the first pulley 31 and the other end is connected to the control member 32. The locking member 34 is radially movable along the rear shaft 231 and disposed in the first locking groove 212. The linkage member 35 is pivotally connected to the front wheel bracket 22 about a first shaft 351 and pivotally connected to the support frame 23 about a second shaft 352. The front shaft 221, rear shaft 231, first shaft 351, and second shaft 352 are all arranged in parallel. When the folding mechanism 30 is in the unfolded state, the locking member 34 is embedded in the notch 232, such that the support frame 23 is prevented from rotating relative to the rear wheel bracket 21. The push rod 24 is rotated to the folded-back position to switch the folding mechanism 30 to the folded state. When the folding mechanism 30 is in the folded state, the control member 32 pushes the locking member 34 out of the notch 232, such that the support frame 23 and the front wheel bracket 22 rotate synchronously relative to the rear wheel bracket 21.

The front wheel bracket 22 is provided with a second locking groove 222 along a direction parallel to the front shaft 221. The second locking groove 222 includes a movable portion 223 and a locking portion 224. The movable portion 223 is arcuate about the front shaft 221. The locking portion 224 is connected to the movable portion 223 and extends radially along the front shaft 221. When the folding mechanism 30 is in the unfolded state, the locking member 34 is disposed in the locking portion 224 to prevent the front wheel bracket 22 from rotating relative to the rear wheel bracket 21. When the folding mechanism 30 is in the folded state, the locking member 34 moves into the movable portion 223, and the locking member 34 moves within the movable portion 223 as the front wheel bracket 22 rotates.

The rear wheel bracket 21 is provided with two stabilizing blocks 213 and two elastic members 214. The two stabilizing blocks 213 are disposed on two opposite axial sides of the rear wheel bracket 21 and are radially movable along the rear shaft 231. The two stabilizing blocks 213 are respectively connected to two opposite ends of the locking member 34. The two elastic members 214 are connected to the two stabilizing blocks 213. One end of each elastic member 214 abuts against the rear wheel bracket 21 and the other end abuts against the corresponding stabilizing block 213, such that the two elastic members 214 can push the two stabilizing blocks 213 to drive the locking member 34 toward the rear shaft 231.

The rear wheel bracket 21 is provided with a limiting rod 215 along a direction parallel to the front shaft 221. The front wheel bracket 22 is provided with a limiting slot 225 along the direction parallel to the front shaft 221. The limiting slot 225 is arcuate about the front shaft 221. The limiting rod 215 is movably inserted into the limiting slot 225.

The support frame 23 is provided with a plug member 233, a plug spring 234, and a cross rod 235. The plug member 233 is radially movable within the support frame 23 along the rear shaft 231. The plug spring 234 is disposed in the support frame 23. One end of the plug spring 234 abuts against the support frame 23 and the other end abuts against the plug member 233 to push the plug member 233 away from the rear shaft 231. The plug member 233 has a closed end 236 opposite to the plug spring 234. The closed end 236 is disposed in the notch 232. One end of the cross rod 235 is slidably connected to the control member 32 and the other end is connected to the plug member 233. When the folding mechanism 30 is in the unfolded state, the closed end 236 abuts against the locking member 34. When the folding mechanism 30 is in the folded state, the closed end 236 moves away from the rear shaft 231 and blocks the notch 232.

The folding mechanism 30 further includes a return elastic member 36 sleeved on the first pull cord 33. One end of the return elastic member 36 abuts against the support frame 23 and the other end abuts against the control member 32.

The support frame 23 is provided with a first engaging portion 237. The push rod 24 is provided with a shaft rod 241, a second engaging portion 242, and a push button 243. The shaft rod 241 passes through the first engaging portion 237 and is pivotally connected to the support frame 23. The first engaging portion 237 and the second engaging portion 242 are adjacent to and surround the shaft rod 241. The folding mechanism 30 further includes a second pulley 37 and an engaging member 38. The second pulley 37 is rotatably sleeved on the shaft rod 241 and disposed within the second engaging portion 242. The second pulley 37 is connected to a second pull cord 371. One end of the second pull cord 371 opposite to the second pulley 37 is connected to the push button 243. The engaging member 38 is axially slidably sleeved on the shaft rod 241. When the push button 243 is released, the engaging member 38 engages both the first engaging portion 237 and the second engaging portion 242 to hold the push rod 24 in the unfolded position. When the push button 243 is pressed, the second pulley 37 is driven by the second pull cord 371 to push the engaging member 38 toward the support frame 23 and disengage the engaging member 38 from the second engaging portion 242, allowing the push rod 24 to rotate relative to the support frame 23.

The baby stroller 10 can be folded and significantly reduced in volume through the above structure. By pressing the push button 243 and folding the push rod 24 forward, the folding mechanism 30 can be switched to the folded state. Once the locking of the folding mechanism 30 is released, the rear wheel bracket 21, the front wheel bracket 22, and the support frame 23 cooperate with the linkage member 35 to form a four-bar linkage, allowing the front wheel bracket 22 and the support frame 23 to fold synchronously toward the rear wheel bracket 21. After folding, the rear wheel bracket 21, the front wheel bracket 22, the support frame 23, and the push rod 24 overlap adjacent to one another, thereby significantly reducing the overall volume of the baby stroller 10 and facilitating storage. The folding operation can be completed with one hand, allowing a user to fold the baby stroller 10 using the other hand while retrieving items or holding a baby.

Although specific embodiments have been illustrated and described, numerous modifications and variations are still possible without departing from the scope of the invention. The scope of the invention is limited by the accompanying claims.

1. A foldable baby stroller, comprising:
a stroller frame including a rear wheel bracket, a front wheel bracket, a support frame, and a push rod, wherein one end of the rear wheel bracket is provided with a joint internally provided with a first locking groove, wherein the front wheel bracket is pivotally connected to the joint about a front shaft, wherein the support frame is pivotally connected to the joint about a rear shaft, wherein the support frame is provided with a notch along a radial outer periphery of the rear shaft, and wherein the push rod is pivotally connected to the support frame and is rotatable between an unfolded position and a folded-back position; and
a folding mechanism switchably connected to the stroller frame between an unfolded state and a folded state, wherein the folding mechanism includes a first pulley, a control member, a first pull cord, a locking member, and a linkage member, wherein the first pulley is pivotally connected to the support frame and rotatable with the push rod, wherein the control member is pivotally connected to the support frame, wherein one end of the first pull cord is connected to the first pulley and the other end is connected to the control member, wherein the locking member is radially movable along the rear shaft and disposed in the first locking groove, wherein the linkage member is pivotally connected to the front wheel bracket about a first shaft and pivotally connected to the support frame about a second shaft, wherein the front shaft, rear shaft, first shaft, and second shaft are all arranged in parallel, wherein when the folding mechanism is in the unfolded state, the locking member is embedded in the notch, such that the support frame is prevented from rotating relative to the rear wheel bracket, wherein the push rod is rotated to the folded-back position to switch the folding mechanism to the folded state, and wherein when the folding mechanism is in the folded state, the control member pushes the locking member out of the notch, such that the support frame and the front wheel bracket rotate synchronously relative to the rear wheel bracket.

2. The foldable baby stroller as claimed in claim 1, wherein the front wheel bracket is provided with a second locking groove along a direction parallel to the front shaft, wherein the second locking groove includes a movable portion and a locking portion, wherein the movable portion is arcuate about the front shaft, wherein the locking portion is connected to the movable portion and extends radially along the front shaft, wherein when the folding mechanism is in the unfolded state, the locking member is disposed in the locking portion to prevent the front wheel bracket from rotating relative to the rear wheel bracket, and wherein when the folding mechanism is in the folded state, the locking member moves into the movable portion, and the locking member moves within the movable portion as the front wheel bracket rotates.

3. The foldable baby stroller as claimed in claim 1, wherein the rear wheel bracket is provided with two stabilizing blocks and two elastic members, wherein the two stabilizing blocks are disposed on two opposite axial sides of the rear wheel bracket and are radially movable along the rear shaft, wherein the two stabilizing blocks are respectively connected to two opposite ends of the locking member, wherein the two elastic members are connected to the two stabilizing blocks, and wherein one end of each elastic member abuts against the rear wheel bracket and the other end abuts against the corresponding stabilizing block, such that the two elastic members can push the two stabilizing blocks to drive the locking member toward the rear shaft.

4. The foldable baby stroller as claimed in claim 1, wherein the rear wheel bracket is provided with a limiting rod along a direction parallel to the front shaft, wherein the front wheel bracket is provided with a limiting slot along the direction parallel to the front shaft, wherein the limiting slot is arcuate about the front shaft, and wherein the limiting rod is movably inserted into the limiting slot.

5. The foldable baby stroller as claimed in claim 1, wherein the support frame is provided with a plug member, a plug spring, and a cross rod, wherein the plug member is radially movable within the support frame along the rear shaft, wherein the plug spring is disposed in the support frame, wherein one end of the plug spring abuts against the support frame and the other end abuts against the plug member to push the plug member away from the rear shaft, wherein the plug member has a closed end opposite to the plug spring, wherein the closed end is disposed in the notch, wherein one end of the cross rod is slidably connected to the control member and the other end is connected to the plug member, wherein when the folding mechanism is in the unfolded state, the closed end abuts against the locking member, and wherein when the folding mechanism is in the folded state, the closed end moves away from the rear shaft and blocks the notch.

6. The foldable baby stroller as claimed in claim 1, wherein the folding mechanism further includes a return elastic member sleeved on the first pull cord, and wherein one end of the return elastic member abuts against the support frame and the other end abuts against the control member.

7. The foldable baby stroller as claimed in claim 1, wherein the support frame is provided with a first engaging portion, wherein the push rod is provided with a shaft rod, a second engaging portion, and a push button, wherein the shaft rod passes through the first engaging portion and is pivotally connected to the support frame, wherein the first engaging portion and the second engaging portion are adjacent to and surround the shaft rod, wherein the folding mechanism further includes a second pulley and an engaging member, wherein the second pulley is rotatably sleeved on the shaft rod and disposed within the second engaging portion, wherein the second pulley is connected to a second pull cord, wherein one end of the second pull cord opposite to the second pulley is connected to the push button, wherein the engaging member is axially slidably sleeved on the shaft rod, wherein when the push button is released, the engaging member engages both the first engaging portion and the second engaging portion to hold the push rod in the unfolded position, and wherein when the push button is pressed, the second pulley is driven by the second pull cord to push the engaging member toward the support frame and disengage the engaging member from the second engaging portion, allowing the push rod to rotate relative to the support frame.
